(19) United States
(12) Patent Application Publication
(10) Pub. No.: US 2023/0040815 A1
(43) Pub. Date: Feb. 9, 2023

(54) AIR VENT ASSEMBLY

(71) Applicant: Shanghai Yanfeng Jinqiao Automotive Trim Systems Co. Ltd., Novi, MI (US)

(72) Inventors: Jianghe ZOU, Shanghai (CN); Xinqing ZHU, Shanghai (CN); Yun LU, Shanghai (CN)

(21) Appl. No.: 17/965,560

(22) Filed: Oct. 13, 2022

Related U.S. Application Data
(63) Continuation of application No. PCT/CN2021/087489, filed on Apr. 15, 2021.

(30) Foreign Application Priority Data
Apr. 16, 2020 (CN) 202010297589.1

(51) Int. Cl. B60H 1/34

(52) U.S. Cl. CPC B60H 1/3414

(57) ABSTRACT

An air vent assembly for a vehicle interior component configured to provide air flow at an outlet from a ventilation system may comprise a housing providing an air flow passage, a cover, a vane assembly to adjust air flow direction at an outlet, a valve assembly to adjust air flow volume from an inlet, a shaft within the passage and an adjuster to adjust air flow direction and/or volume. The vane assembly may comprise a set of vanes to rotate at a ball joint or universal joint to adjust air flow direction. The shaft may be coupled to the valve assembly by a gear mechanism to adjust air flow volume. The assembly may comprise a light module to provide illumination at the outlet. The light source may illuminate a light-transmissive element within the cover. The vane assembly may comprise the light transmissive element.

### CROSS-REFERENCE TO RELATED APPLICATIONS

The present application is a continuation of PCT/International Patent Application No. PCT/CN2021/087489 titled “AIR VENT ASSEMBLY” filed Apr. 15, 2021, which claims the benefit of Chinese Patent Application No. 202010297589.1 filed Apr. 16, 2020.

The present application claims priority to and incorporates by reference in full the following patent applications: (a) Chinese Patent Application No. 202010297589.1 filed Apr. 16, 2020; (b) PCT/International Patent Application No. PCT/CN2021/087489 titled “AIR VENT ASSEMBLY” filed Apr. 15, 2021.

### FIELD

The present invention relates to an air vent assembly.

### BACKGROUND

It is well-known to provide an air vent assembly for a vehicle interior.

It would be advantageous to provide an improved air vent assembly for a vehicle interior configured to provide for adjustment of air flow volume and/or air flow direction.

It would be advantageous to provide an improved air vent assembly for a vehicle interior comprising an adjuster configured to provide for independent adjustment of air flow volume and air flow direction.

It would be advantageous to provide an improved air vent assembly for a vehicle interior configured to provide for illumination of translucent elements to provide a visual effect.

### SUMMARY

The present invention relates to a component for a vehicle interior providing a passage for airflow and comprising (a) a valve assembly comprising a door; (b) a vane assembly comprising a guide configured to guide airflow; (c) a knob configured to move at least one of the door or the guide; and (d) a light source. The light source may be configured to illuminate the knob. The component may comprise a light guide configured to direct light from the light source toward the knob. The light guide may comprise an angled surface configured to direct light from a transverse direction to a direction generally orthogonal to the transverse direction. The component may comprise a shaft coupled to the knob. The shaft may be configured to move the door between an open position to allow airflow and a closed position to block airflow. The shaft may comprise an opening. The component may comprise a light guide configured to direct light from the light source toward the knob; the light guide may be positioned within the opening of the shaft.

The present invention relates to an air conditioning device for a vehicle interior comprising an air direction transmission structure and an air volume transmission structure. The air direction transmission structure and the air volume transmission structure may be arranged on a shell. A shell cavity may axially protrude out of an interior of the shell. The air direction transmission structure may be mounted on an outside of the shell cavity to adjust a blowing angle. The air volume transmission structure may be mounted on an inside of the shell cavity to adjust a blowing force. The air volume transmission structure may comprise a knob assembly, an air volume bushing, a transmission shaft and an air door. The transmission shaft may be connected with the air door. The knob assembly may be mounted on the transmission shaft through an air volume universal joint pair by means of the air volume bushing. A knob spherical cavity may protrude out of the knob assembly; the knob spherical cavity may comprise opposite knob characteristic holes; the transmission shaft may comprise opposite transmission characteristic shafts; the air volume bushing may be provided between the knob spherical cavity and the transmission shaft; the transmission shaft may comprise opposite air volume characteristic shafts and opposite air volume characteristic holes; the air volume characteristic shafts may be inserted into the knob characteristic holes; the transmission characteristic shafts may be inserted into the air volume characteristic holes to form an air volume universal joint pair. An axis of the air volume characteristic shafts may be perpendicular to a line connecting the air volume characteristic holes. The air direction transmission structure may comprise an air guiding grill and an air direction bushing; the air guiding grill may be mounted on the shell cavity through an air direction universal joint pair by means of the air direction bushing. An interior of the air guiding grill may be provided with a sleeve in an axial direction; the sleeve may comprise opposite grill characteristic holes. The shell cavity may comprise opposite shell characteristic shafts; the air direction bushing may be provided between the sleeve and the shell cavity. The air direction bushing may comprise opposite air direction characteristic shafts and opposite air direction characteristic holes; the air direction characteristic shafts may be inserted into the grill characteristic holes for cooperation; the shell characteristic shafts may be inserted into the air direction characteristic holes to form an air direction universal joint pair. An axis of the air direction characteristic shafts may be perpendicular to a line connecting the air direction characteristic holes. The air direction transmission structure may comprise an air guiding grill, a grill carrier, and an elastic body. The air guiding grill may be mounted on the shell cavity through a ball joint pair by means of the grill carrier and the elastic body. The grill carrier may comprise a spherical inner side wall adapted to a shape of the shell cavity to be loaded on the outside of the shell cavity. An annular groove may be formed in the spherical inner side wall; the elastic body may be accommodated in the annular groove to form a ball joint pair. The knob assembly may comprise a knob mounted on the air guiding grill configured to rotate about a central axis of the air guiding grill and a knob carrier captured inside the knob. The air volume transmission structure may comprise a gear connected between the transmission shaft and the air door.

The present invention relates to an air vent assembly for a vehicle interior component configured to provide air flow at an outlet from a ventilation system comprising (a) a housing providing a passage for air flow between an inlet and the outlet; (b) a cover; (c) a vane assembly configured to adjust direction of air flow at the outlet; (d) a valve assembly configured to adjust volume of air flow from the inlet; (e) a shaft within the passage; (f) an adjuster configured to adjust at least one of direction of air flow and/or volume of air flow; and (g) a light module configured to provide illumination at the outlet. Illumination at the outlet may comprise illumination of a set of light-transmissive elements within the cover to provide a visual effect. The adjuster may be configured independently to adjust direction of air flow and volume of air flow. The light module may comprise a light source. The light source may be configured to illuminate a light-transmissive element within the cover.

The present invention relates to an air vent assembly for a vehicle interior component configured to provide air flow at an outlet from a ventilation system comprising a housing providing a passage for air flow between an inlet and the outlet, a cover, a vane assembly configured to adjust direction of air flow at the outlet, a valve assembly configured to adjust volume of air flow from the inlet, a shaft within the passage and an adjuster configured to adjust at least one of direction of air flow and/or volume of air flow. The shaft may be between the vane assembly and the valve assembly. The shaft may be coupled to the vane assembly by a joint such as a ball joint. The shaft may be coupled to the valve assembly at an interface. The adjuster may comprise an operator control. The adjuster may comprise a knob. The adjuster may be coupled to the shaft by a joint such as a universal joint. The adjuster may be within the cover. The adjuster may comprise a rotatable operator control. The adjuster may comprise a rotatable operator control configured to adjust volume of air flow at the valve assembly. The adjuster may be configured to adjust direction of air flow and volume of air flow. The adjuster may be configured independently to adjust direction of air flow and volume of air flow. The adjuster may be configured to adjust direction of air flow at the outlet and volume of air flow at the inlet. The adjuster may be configured to adjust direction of air flow through the outlet and volume of air flow through the outlet. The valve assembly may comprise a set of valves configured to adjust volume of air flow. The valve assembly may be configured to provide a closed position to obstruct air flow and an open position to permit air flow. The vane assembly may comprise a set of vanes. The vane assembly may comprise a header. The vane assembly may be at least partially within the cover. The vane assembly may be configured to move within the cover to adjust the direction of air flow at the outlet. The vane assembly may be coupled to the adjuster at a joint. The vane assembly may be configured to pivot at the joint to adjust the direction of air flow at the outlet. The vane assembly may comprise a set of vanes configured to rotate at the joint to adjust direction of air flow. The vane assembly may be coupled to the adjuster so that the vane assembly can be rotated. The vane assembly may comprise a circular structure. The vane assembly may comprise a set of vanes configured to guide air flow. The adjuster may be configured to adjust the vane assembly. The air valve assembly may comprise a joint; the joint may comprise a ball joint; the joint may comprise a universal joint. The valve assembly may be at the inlet. The valve assembly may be configured to open and to close the inlet. The valve assembly may be within the passage. The valve assembly may comprise a set of valves. The set of valves may be movable between an open position and a closed position. Housing HS may comprise a seat for the set of valves. The seat may comprise a seal for air flow at the inlet. The shaft may couple the adjuster to the valve assembly. The shaft may be coupled to the valve assembly by an interface. The interface may comprise a mechanism. The mechanism may comprise a gear mechanism. The valve assembly may comprise a set of valves coupled to the shaft at the mechanism. The set of valves may comprise a set of doors. The set of doors may be rotatably movable between an open position and a closed position. The set of doors may comprise flaps. The adjuster may be configured to adjust the valve assembly. The adjuster may be configured to adjust volume of air flow. The adjuster may be configured to adjust the valve assembly between an open position and a closed position. The cover may comprise a cap. The vane assembly may comprise a bezel; the vane assembly may be moveable within the cap. The adjuster may comprise a knob on the vane assembly. The adjuster may comprise a knob within the cover connected to the shaft. The knob may be configured to adjust position of the vane assembly to direct air flow at the outlet. The knob may be configured to adjust position of the valve assembly between an open position and a closed position. The assembly may comprise a light module configured to provide illumination at the outlet. The light module may comprise a light source. The light source may comprise an LED. The light source may be configured to illuminate a light-transmissive element within the cover. The vane assembly may comprise the light transmissive element. The assembly may comprise a light guide between the light source and the light transmissive element. The light guide may comprise a section within the shaft. Illumination at the outlet may comprise a visual effect. Illumination at the outlet may comprise illumination of a set of light transmissive elements within the cover. Illumination at the outlet may comprise illumination of the adjuster.

The present invention relates to a vehicle interior component providing a passage for airflow and comprising a valve assembly comprising a door, a vane assembly comprising a guide configured to guide airflow and a knob. The knob may be configured to move the door between an open position to allow airflow and a closed position to block airflow; the knob may be configured to move the guide between a first position to guide airflow in a first direction and a second position to guide airflow in a second direction. The knob may be configured to translate to move the door between the open position and the closed position. The knob may be configured to rotate to move the guide between the first position and the second position. The guide may comprise a set of vanes.

The present invention relates to a vehicle interior component providing a passage for airflow and comprising a valve assembly comprising a door, a vane assembly comprising a guide configured to guide airflow, a knob configured to move at least one of the door or the guide and a light source. The light source may be configured to illuminate the knob. The component may comprise a light guide configured to direct light from the light source toward the knob. The light guide may comprise an angled surface configured to direct light from a transverse direction to a direction generally orthogonal to the transverse direction. The component may comprise a shaft coupled to the knob. The shaft may be configured to move the door between an open position to allow airflow and a closed position to block airflow. The shaft may comprise an opening. The component may comprise a light guide configured to direct light from the light source toward the knob; the light guide may be positioned within the opening of the shaft.

The present invention relates to an air conditioning device comprising an air direction transmission structure and an air volume transmission structure. The air direction transmission structure and the air volume transmission structure may be arranged on a shell. A shell cavity may protrude axially out of an interior of the shell. The air direction transmission structure may be mounted on an outside of the shell cavity to adjust a blowing angle. The air volume transmission structure may be mounted on an inside of the shell cavity to adjust a blowing force. The air volume transmission structure may comprise a knob assembly, an air volume bushing, a transmission shaft and an air door. The transmission shaft may be connected with the air door. The knob assembly may be mounted on the transmission shaft through an air volume universal joint pair by means of the air volume bushing. A knob spherical cavity may protrude out of the knob assembly; the knob spherical cavity may comprise opposite knob characteristic holes; the transmission shaft may comprise opposite transmission characteristic shafts; the air volume bushing may be provided between the knob spherical cavity and the transmission shaft; the transmission shaft may comprise opposite air volume characteristic shafts and opposite air volume characteristic holes; the air volume characteristic shafts may be inserted into the knob characteristic holes; the transmission characteristic shafts may be inserted into the air volume characteristic holes to form an air volume universal joint pair. An axis of the air volume characteristic shafts may be perpendicular to a line connecting the air volume characteristic holes. The air direction transmission structure may comprise an air guiding grill and an air direction bushing; the air guiding grill may be mounted on the shell cavity through an air direction universal joint pair by means of the air direction bushing. An interior of the air guiding grill may be provided with a sleeve in an axial direction; the sleeve may comprise opposite grill characteristic holes; the shell cavity may comprise opposite shell characteristic shafts; the air direction bushing may be provided between the sleeve and the shell cavity; the air direction bushing may comprise opposite air direction characteristic shafts and opposite air direction characteristic holes; the air direction characteristic shafts may be inserted into the grill characteristic holes for cooperation; the shell characteristic shafts may be inserted into the air direction characteristic holes to form an air direction universal joint pair. An axis of the air direction characteristic shafts may be perpendicular to a line connecting the air direction characteristic holes. The air direction transmission structure may comprise an air guiding grill, a grill carrier, and an elastic body; the air guiding grill may be mounted on the shell cavity through a ball joint pair by means of the grill carrier and the elastic body. The grill carrier may comprise a spherical inner side wall adapted to a shape of the shell cavity to be loaded on the outside of the shell cavity; an annular groove may be formed in the spherical inner side wall; the elastic body may be accommodated in the annular groove to form a ball joint pair. The knob assembly may comprise a knob mounted on the air guiding grill configured to rotate about a central axis of the air guiding grill and a knob carrier captured inside the knob. The air volume transmission structure may comprise a gear connected between the transmission shaft and the air door.

The present invention relates to an air vent assembly for a vehicle interior component configured to provide air flow at an outlet from a ventilation system comprising a housing providing a passage for air flow between an inlet and the outlet, a cover, a vane assembly configured to adjust direction of air flow at the outlet, a valve assembly configured to adjust volume of air flow from the inlet, a shaft within the passage, an adjuster configured to adjust at least one of direction of air flow and/or volume of air flow and a light module configured to provide illumination at the outlet. Illumination at the outlet may comprise illumination of a set of light-transmissive elements within the cover to provide a visual effect.

### FIGURES

FIG. 1A is a schematic perspective view of a vehicle according to an exemplary embodiment.

FIGS. 1B and 2 are schematic perspective views of a vehicle interior according to an exemplary embodiment.

FIGS. 3A through 3C are schematic plan views of a vehicle interior component according to an exemplary embodiment.

FIG. 4A is a schematic perspective view of a vehicle interior component according to an exemplary embodiment.

FIGS. 4B and 4C are schematic partial perspective views of a vehicle interior component according to an exemplary embodiment.

FIG. 5A is a schematic partial exploded perspective view of a vehicle interior component according to an exemplary embodiment.

FIG. 5B is a schematic exploded perspective view of a vehicle interior component according to an exemplary embodiment.

FIGS. 6A through 6F are schematic plan views of a vehicle interior component according to an exemplary embodiment.

FIGS. 7A through 7F are schematic partial perspective views of a vehicle interior component according to an exemplary embodiment.

FIG. 8A is a schematic perspective view of a vehicle interior component according to an exemplary embodiment.

FIG. 8B is a schematic section view of a vehicle interior component according to an exemplary embodiment.

FIG. 8C is a schematic partial perspective view of a vehicle interior component according to an exemplary embodiment.

FIG. 8D is a schematic section view of a vehicle interior component according to an exemplary embodiment.

FIG. 9A is a schematic perspective view of a vehicle interior component according to an exemplary embodiment.

FIG. 9B is a schematic section view of a vehicle interior component according to an exemplary embodiment.

FIG. 9C is a schematic partial perspective view of a vehicle interior component according to an exemplary embodiment.

FIG. 9D is a schematic section view of a vehicle interior component according to an exemplary embodiment.

FIG. 10A is a schematic perspective view of a vehicle interior component according to an exemplary embodiment.

FIG. 10B is a schematic section view of a vehicle interior component according to an exemplary embodiment.

FIG. 10C is a schematic partial perspective view of a vehicle interior component according to an exemplary embodiment.

FIG. 10D is a schematic section view of a vehicle interior component according to an exemplary embodiment.

FIG. 11A is a schematic perspective view of a vehicle interior component according to an exemplary embodiment.

FIG. 11B is a schematic section view of a vehicle interior component according to an exemplary embodiment.

FIG. 11C is a schematic partial perspective view of a vehicle interior component according to an exemplary embodiment.

FIG. 11D is a schematic section view of a vehicle interior component according to an exemplary embodiment.

FIG. 12A is a schematic perspective view of a vehicle interior component according to an exemplary embodiment.

FIG. 12B is a schematic section view of a vehicle interior component according to an exemplary embodiment.

FIG. 12C is a schematic partial perspective view of a vehicle interior component according to an exemplary embodiment.

FIG. 12D is a schematic section view of a vehicle interior component according to an exemplary embodiment.

FIG. 13A is a schematic perspective view of a vehicle interior component according to an exemplary embodiment.

FIG. 13B is a schematic section view of a vehicle interior component according to an exemplary embodiment.

FIG. 13C is a schematic partial perspective view of a vehicle interior component according to an exemplary embodiment.

FIG. 13D is a schematic section view of a vehicle interior component according to an exemplary embodiment.

FIG. 14A is a schematic partial exploded section perspective view of a vehicle interior component according to an exemplary embodiment.

FIG. 14B is a schematic partial exploded section perspective view of a vehicle interior component according to an exemplary embodiment.

FIG. 15 is a schematic section view of a vehicle interior component according to an exemplary embodiment.

FIG. 16 is a schematic section view of a vehicle interior component according to an exemplary embodiment.

FIG. 17A is a schematic perspective view of a vehicle interior component according to an exemplary embodiment.

FIG. 17B is a schematic partial perspective view of a vehicle interior component according to an exemplary embodiment.

FIG. 18A is a schematic exploded perspective view of a vehicle interior component according to an exemplary embodiment.

FIG. 18B is a schematic partial exploded perspective view of a vehicle interior component according to an exemplary embodiment.

FIG. 18C is a schematic partial section view of a vehicle interior component according to an exemplary embodiment.

FIG. 19A is a schematic exploded perspective view of a vehicle interior component according to an exemplary embodiment.

FIG. 19B is a schematic partial exploded perspective view of a vehicle interior component according to an exemplary embodiment.

FIG. 19C is a schematic partial section view of a vehicle interior component according to an exemplary embodiment.

### DESCRIPTION

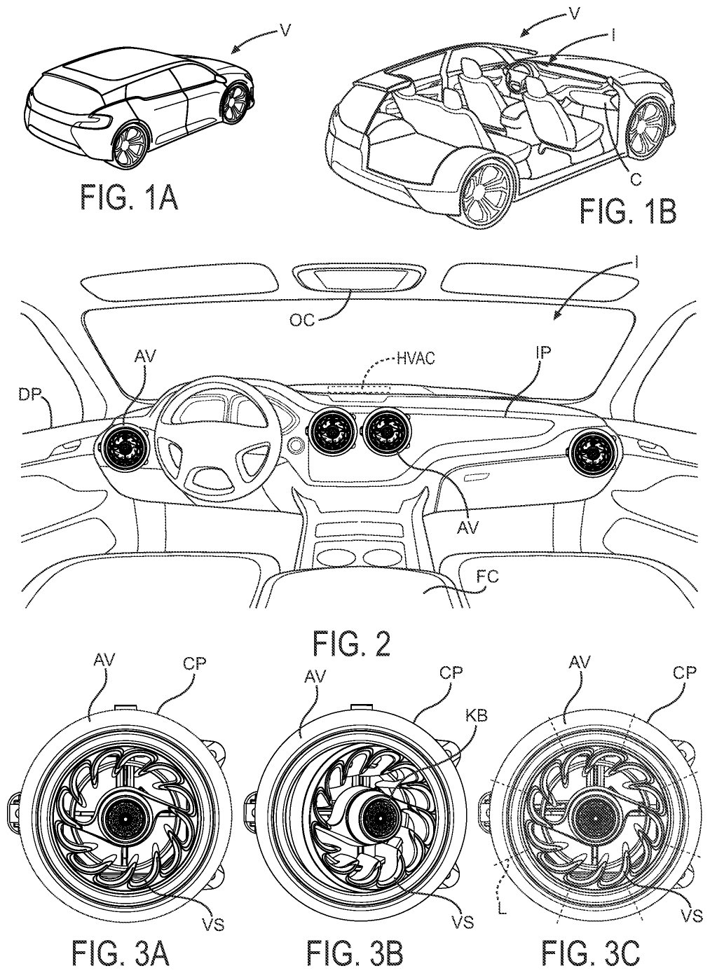

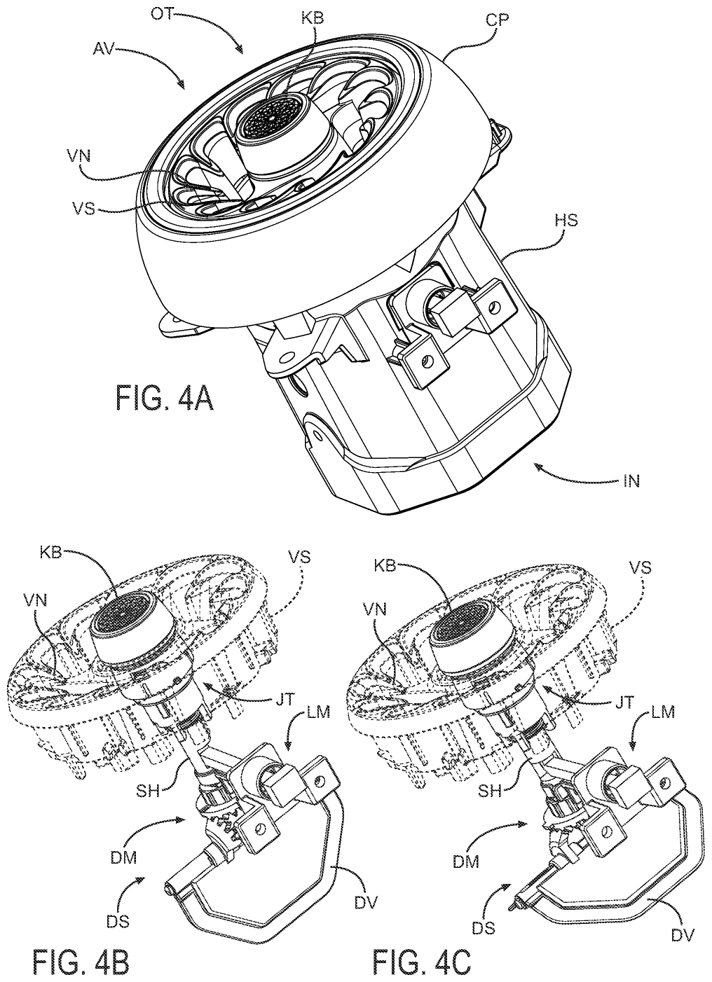

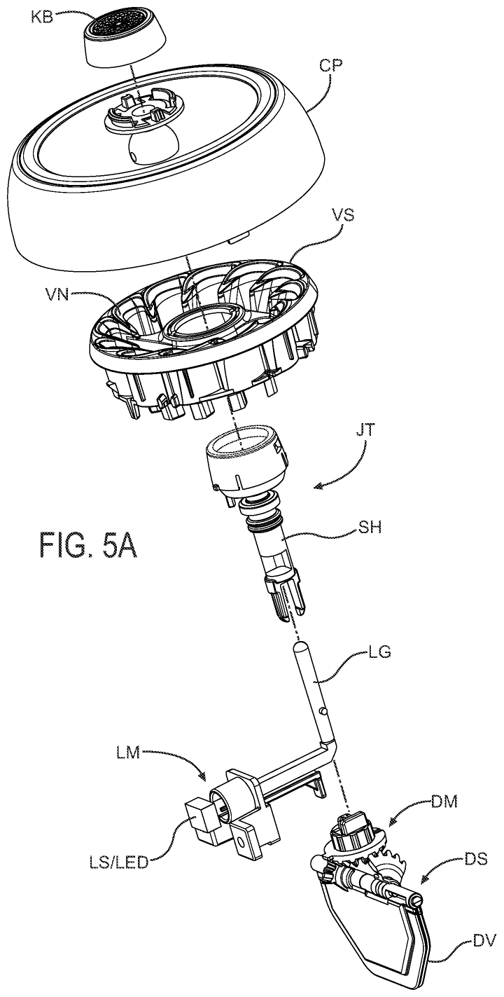

Referring to FIGS. 1A-1B and 2, a vehicle V is shown with an interior I comprising vehicle interior components C such as an instrument panel IP, floor console FC, overhead console OC, door panel DP, etc. As indicated schematically according to an exemplary embodiment in FIGS. 2 and 3A-3C, the vehicle may comprise a ventilation system HVAC (e.g. configured to provide conditioned air for an air conditioning system, heating system, etc.) coupled to provide air flow (e.g. through duct work, with fan, control system, etc.) to a set of air vent assemblies AV within the vehicle interior (e.g. installed into vehicle interior components).

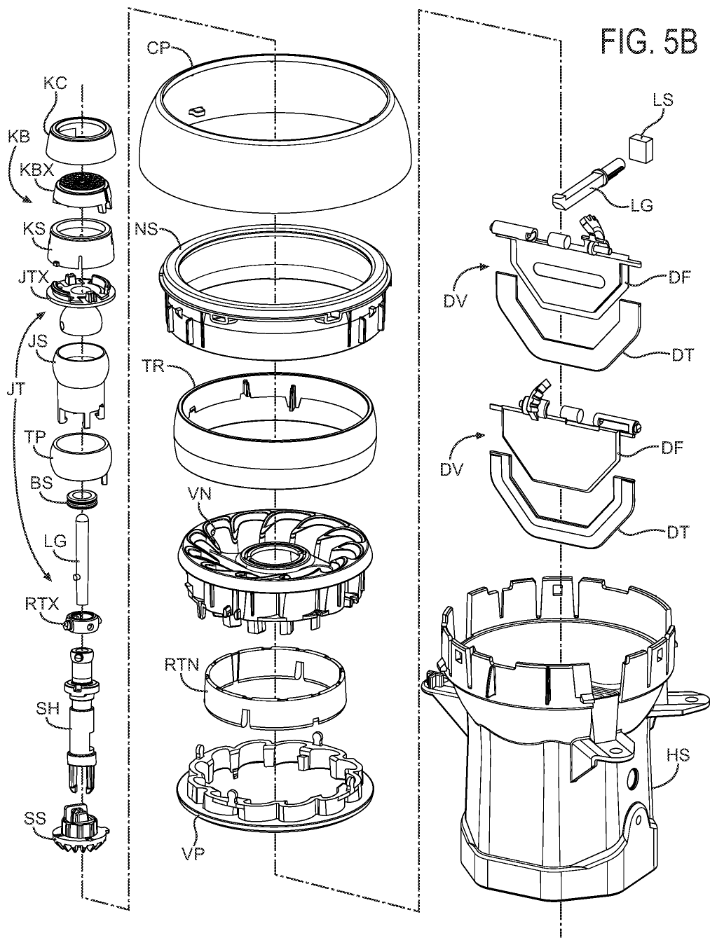

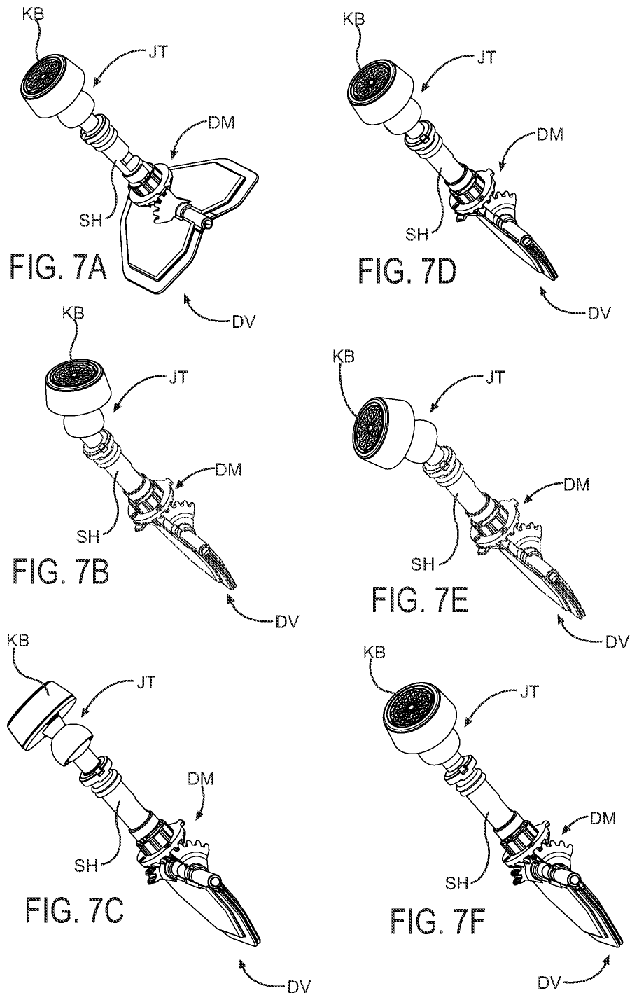

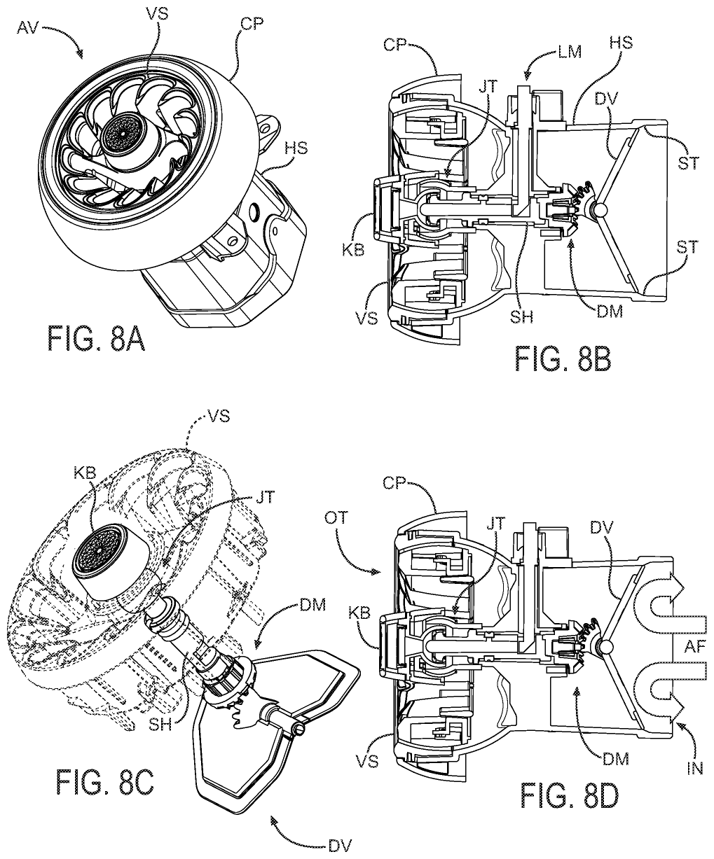

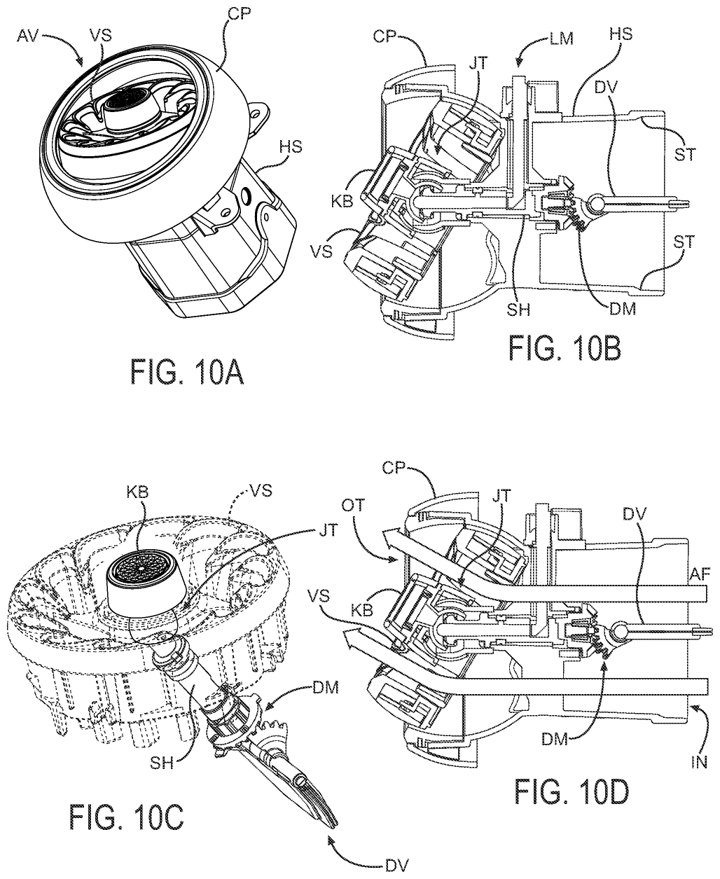

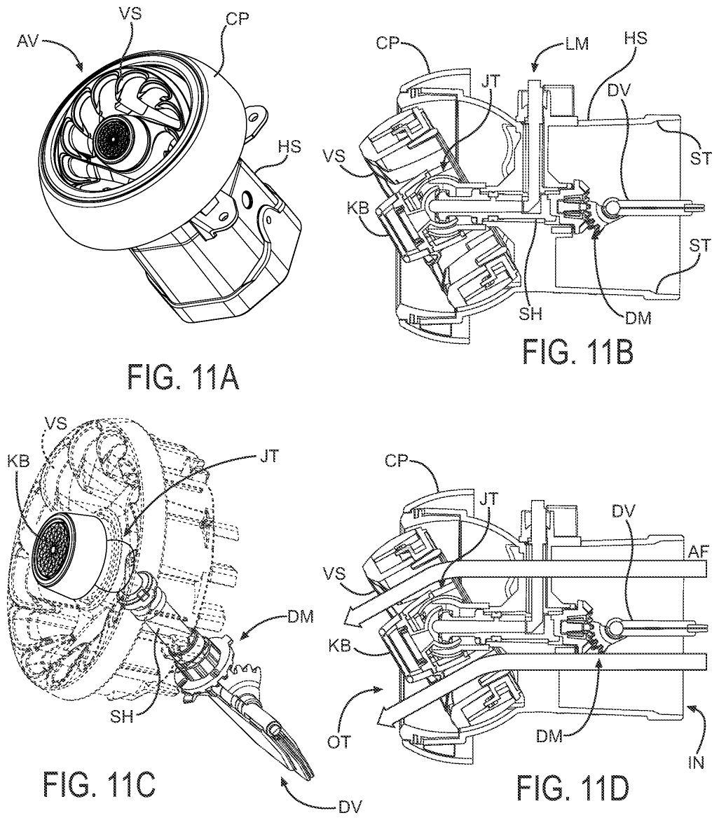

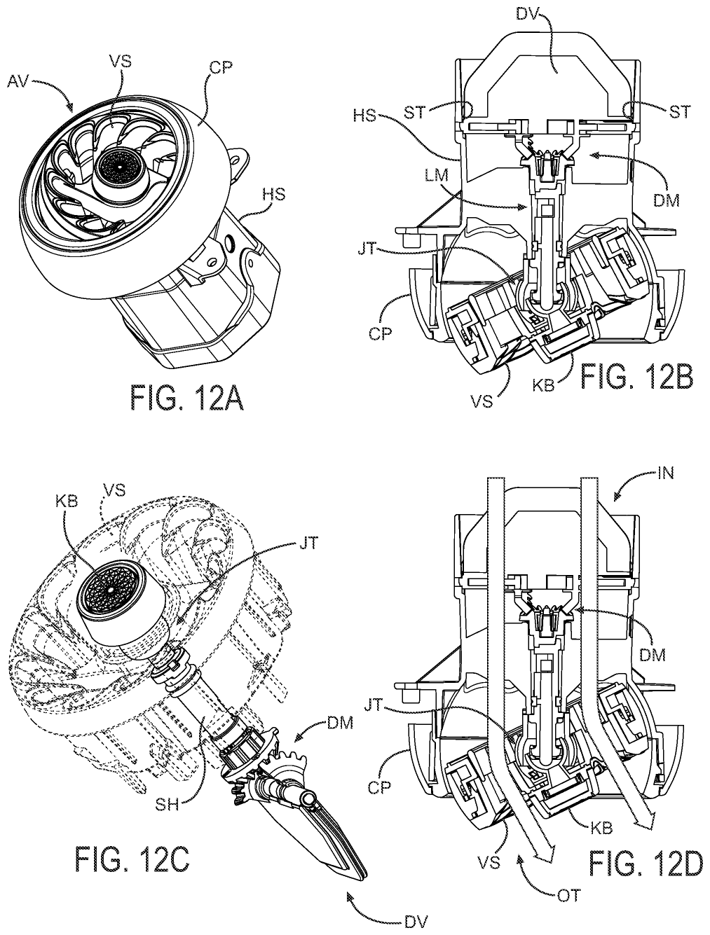

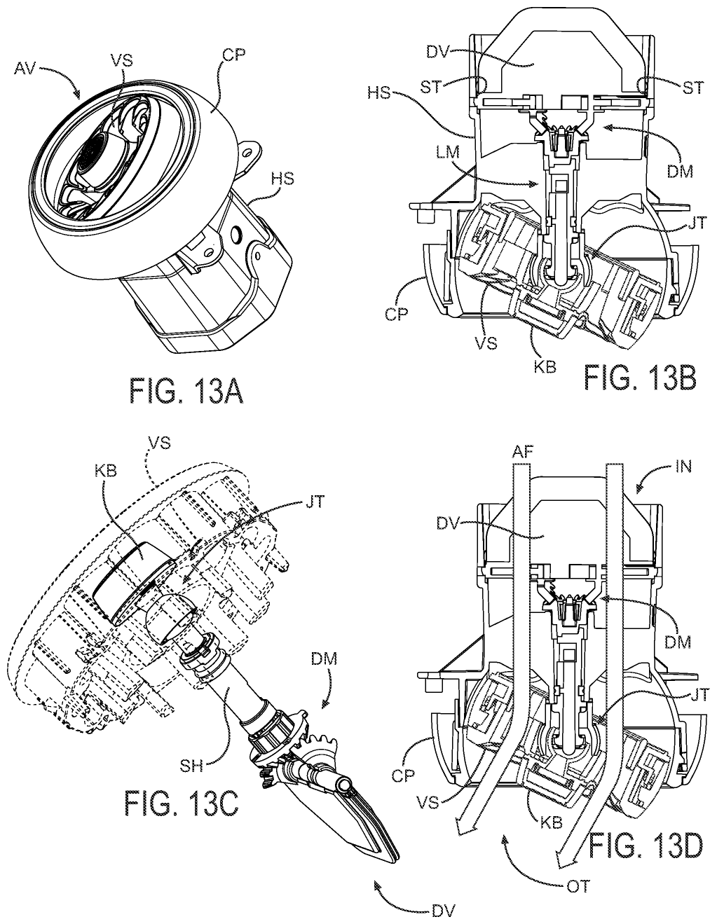

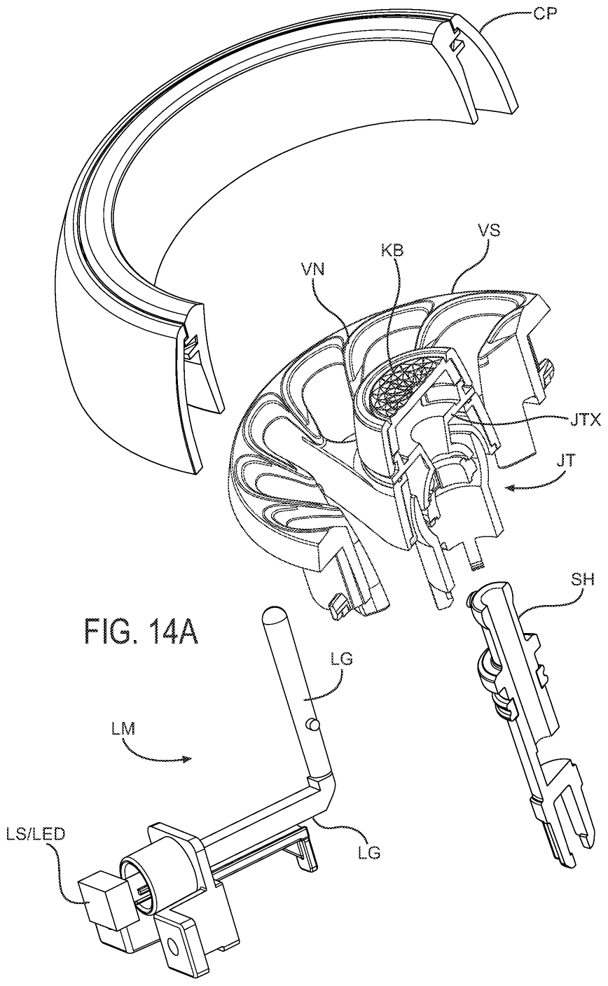

As indicated schematically according to an exemplary embodiment in FIGS. 2, 3A-3C and 4A, each air vent assembly AV may be configured with an operator control/adjuster shown as knob KB to control volume and/or direction of air flow from an inlet IN coupled to the ventilation system through a passage within a housing HS and as directed through a vane assembly VS comprising a header with a set of vanes VN moveable within a cover/cap CP through an outlet OT into the vehicle interior. As shown schematically in FIGS. 3A-3C and 4A-4C, the operator control shown as knob KB may be coupled by a shaft SH to a door mechanism DM of a door assembly DS comprising flow control elements shown as valve doors DV configured to adjust and control volume of air flow (i.e. adjusted to positions between an opened position fully to allow air flow and a closed position fully to obstruct air flow at the inlet) and to vane assembly VS mounted on a coupling/mechanism shown as joint JT on shaft SH (e.g. universal joint permitting swivel/rotational movement) configured with vanes VN to adjust and control direction of air flow (i.e. to direct air flow in a variety of directions into the vehicle interior at the outlet). See also FIGS. 6A-6F, 8A-8D, 9A-9D, 10A-10D, 11A-11D, 12A-12D and 13A-13D. As shown schematically in FIGS. 3A, 4A, 4B and 9A-9D, with knob KB on shaft SH the door assembly DS may be adjusted (e.g. by rotation) to close valve doors DV in order to open passage for air flow volume into the housing HS at inlet IN (e.g. with actuation of a door/gear mechanism). As shown schematically in FIGS. 3C, 4A, 4C and 8A-8D, with knob KB on shaft SH the door assembly DS may be adjusted to open valve doors DV in order to close passage for air flow volume into the housing HS at inlet IN (e.g. with valve doors engaging a seat ST within housing HS). As shown schematically in FIGS. 3B, 4A, 10A-10D, 11A-11D, 12A-12D and 13A-13D, with knob KB the vane assembly VS may be adjusted at joint JT on shaft SH to position vanes VN in order to adjust air flow direction from the housing HS at inlet OT. See also FIGS. 6A-6F and 7A-7F.

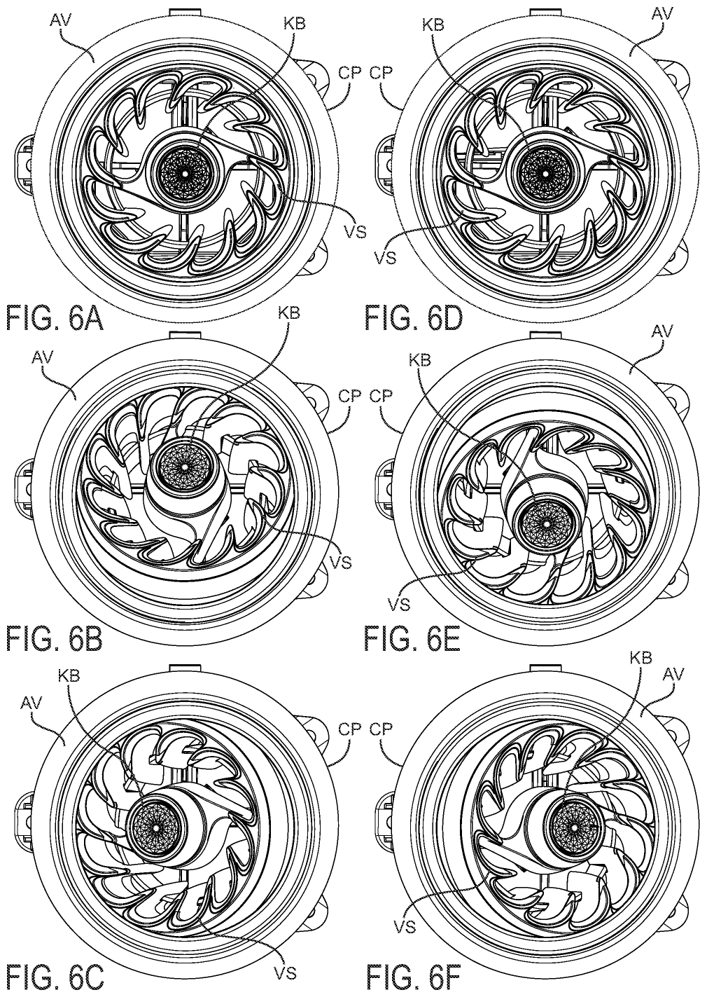

As shown schematically in FIGS. 5A-5B, air vent assembly AV may comprise an operator control shown as knob KB within cover/cap CP with vane assembly VS comprising a set of vanes VN coupled on a joint JT to a shaft SH and to door assembly DS with door mechanism DM for the set of door valves DV comprising door flaps DT each with a door frame DT. As shown schematically in FIG. 5B, the air vent assembly may comprise knob KB assembled with a cap KC and an insert KBX in a housing KS assembled at the joint JT comprising a coupling shown as insert JTX in a joint housing/socket JS with a ring TP (e.g. providing a universal/swivel joint) and a bushing BS on a light guide segment LG retained by a universal joint RTX on shaft SH configured to engage an interface shown as gear SS. As shown schematically in FIG. 5B, the air vent assembly may comprise cover/cap CP with a bezel NS for vane assembly VS with a ring TR and set of vanes VN with a retainer RTN and ring VP. As indicated schematically in FIGS. 4A and 5A-5B, the air vent assembly AV may be assembled within the housing HS containing the shaft SH to provide the inlet IN adjacent to the door valve assembly DS with door mechanism DM (providing a gear mechanism) on shaft SH and the outlet OT at the cover/cap CP and vane assembly VS onto shaft SH with joint JT and operator control/adjuster shown as knob KB.

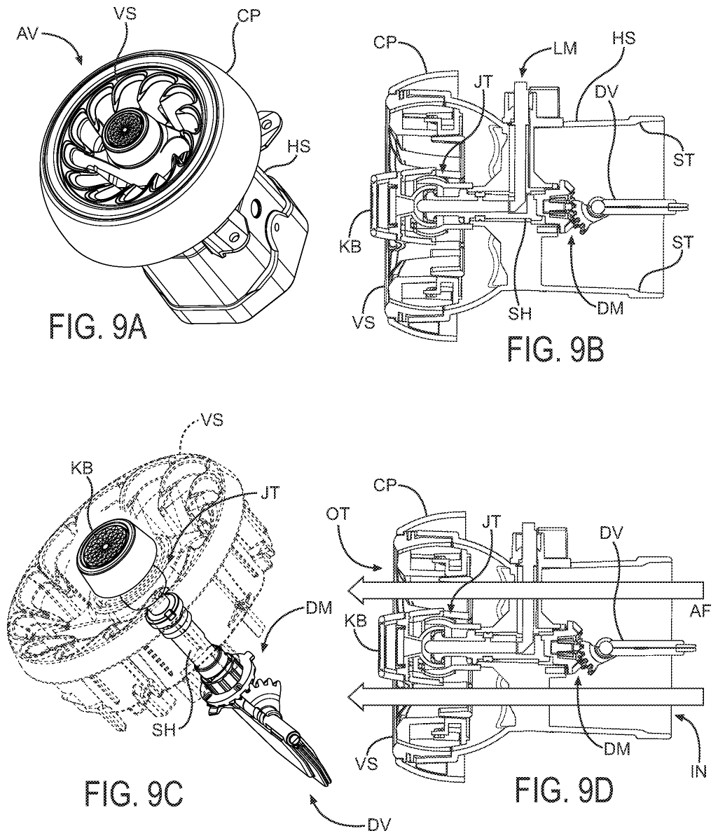

As indicated schematically in FIGS. 4A, 5A-5B and 7A-7F, the joint JT (e.g. comprising the rotating joint/ball joint/universal joint elements) of the air valve assembly AV may be configured to facilitate independent adjustment of the door/valve assembly DS (e.g. adjustment of air flow volume by rotation of adjuster/knob JB to actuate door mechanism DM and door valves DV) at inlet IN and independent adjustment of the vane assembly VS (e.g. adjustment of air flow direction by swivel/rotation of vanes VN within cover/cap CP) at outlet OT. See also FIGS. 8A-8D, 9A-9D, 10A-10D, 11A-11D, 12A-12D and 13A-13D (indicating independent adjustment of volume and direction of air flow AF between inlet IN and outlet OT). According to an exemplary embodiment shown in FIGS. 4A-4C, 5A-5B, 6A-6F and 7A-7F, the adjuster shown as knob KB may be configured so that the volume of air flow (e.g. at the door assembly DS at the inlet) can be adjusted independent of the direction of air flow (e.g. regardless of the position of the vane assembly VS at the outlet); the adjuster shown as knob KB may be configured so that intended direction of air flow (e.g. the position of the vane assembly VS at the outlet) can be adjusted independent of volume of air flow (e.g. regardless of the partial/full opening of air flow volume at the door assembly DS at the inlet).

As indicated schematically in FIGS. 3A-3C, 6A-6F and 7A-7F, the air flow AF of the air vent assembly AV may be adjusted at the operator control/adjuster shown as knob KB on shaft SH coupled to door mechanism DM for valve doors DV for air flow volume to be closed with no air flow volume (FIGS. 6A and 7A with valve doors DV opened and on seat ST within housing HS) or to be open with full air flow volume (FIGS. 6D and 7D with valve doors DV closed within housing HS). See also FIGS. 4A, 8A-8D and 9A-9D (indicating air flow AF between inlet IN and outlet OT).

As indicated schematically in FIGS. 3A-3C, 6A-6F and 7A-7F, the air flow AF of the air vent assembly AV may be adjusted at the operator control/adjuster shown as knob KB within the range of movement of vane assembly VS provided within cover/cap CP for air flow direction to be directed in any of a variety of angled orientations by swivel/movement of the vanes VN of the vane assembly VS on joint JT and shaft SH such as straight/center orientation (see FIGS. 6D/7D) and up/down orientations (compare FIGS. 6B/7B with FIGS. 6E/7E) and side-to-side orientations (compare FIGS. 6C/7C with FIGS. 6F/7F) and other combinations within the unconstrained range of movement within cover/cap CP and on joint JT (e.g. movement as available on a joint comprising a ball joint, swivel joint, universal joint, etc.). See also FIGS. 4A, 10A-10D, 11A-11D, 12A-12D and 13A-13D (indicating air flow AF between inlet IN and outlet OT).

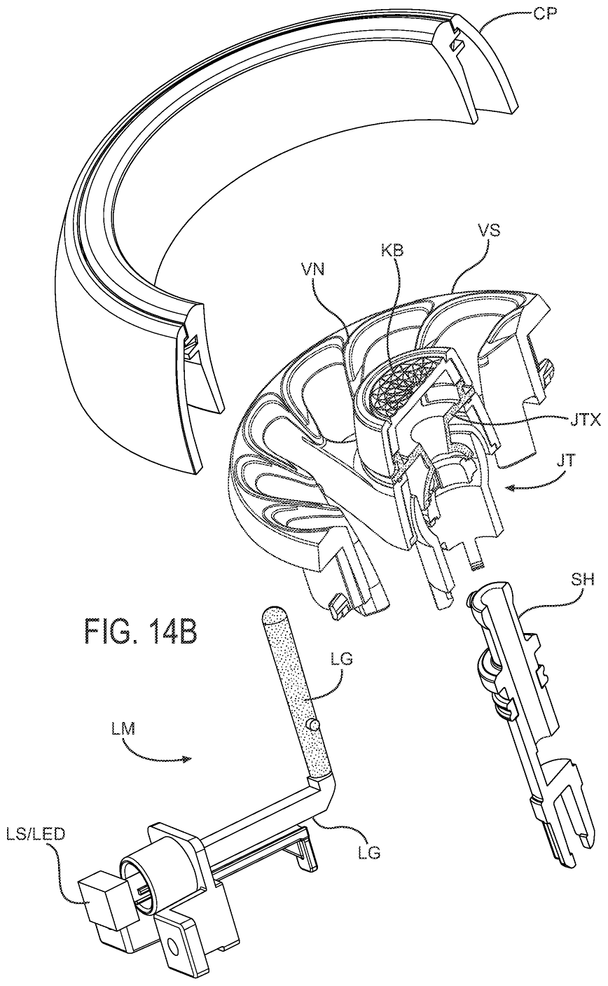

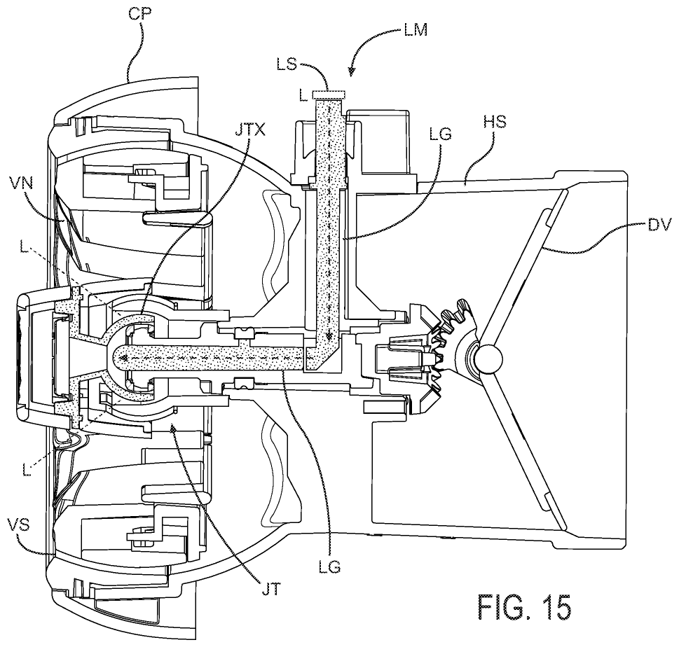

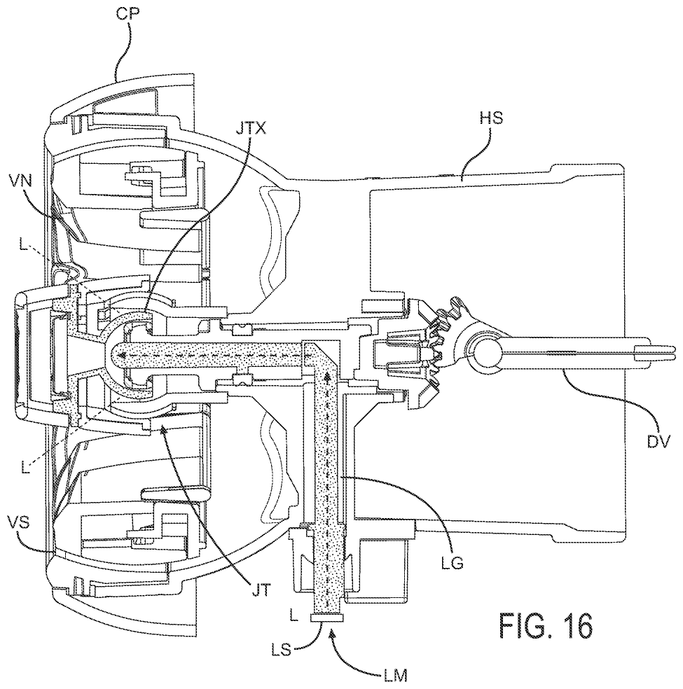

As indicated schematically according to an exemplary embodiment in FIGS. 3C, 4A-4C and 5A-5B, air vent assembly AV may comprise a light module LM configured to direct light L from a light source LS/LED (shown as an LED arrangement) through a light guide LG within shaft SH to provide light L as a visible effect at cover/cap CP and vane assembly VS (e.g. transmission from the light source through light guide/light-transmissive elements to provide light visible to an occupant of the vehicle interior). See also FIGS. 14A-14B, 15 and 16 (indicating light passage/transmission through light guide and light transmissive element JTX). As indicated schematically in FIGS. 3C, 15 and 16, light L from light source LS of light module LM may be presented as a visual effect within the knob KB and vane assembly VS at the outlet within the cover/cap CP of the air vent assembly AV. See also FIGS. 14A-14B. (As indicated schematically in the FIGURES, the light module can be configured to be operated at an operator control such as knob KB and/or by another control element (e.g switch, etc.) for the vehicle.)

According to an exemplary embodiment the air vent assembly may be configured to provide for efficient operation permitting independent adjustment of air flow volume and/or air flow direction. As indicated schematically, the air vent assembly may be configured to provide for adjustment of air flow volume and/or air flow direction. As indicated schematically, the air vent assembly may comprise an adjuster configured to provide for independent adjustment of air flow volume and air flow direction. As indicated schematically, the air vent assembly may be configured to provide for illumination of translucent elements to provide a visual effect within the vehicle interior.

### Exemplary Embodiment—A

According to an exemplary embodiment as shown schematically in FIGS. 3A-3C, 4A-4C, 5A, 5B, 6A-6F, 7A-7F, 8A-8D, 9A-9D, 10A-10D, 11A-11D, 12A-12D, 13A-13D, 14A-14B, 15 and 16, an air vent assembly for a vehicle interior component configured to provide air flow at an outlet OT from a ventilation system HVAC may comprise a housing HS providing a passage for air flow between an inlet IN and outlet OT, a cover CP, a vane assembly VS configured to adjust direction of air flow at outlet OT, a valve assembly DS configured to adjust volume of air flow from inlet IN, a shaft SH within passage and an adjuster KB configured to adjust at least one of direction of air flow and/or volume of air flow. Shaft SH may be between vane assembly VS and valve assembly DS. Shaft SH may be coupled to vane assembly VS by a joint JT. Shaft SH may be coupled to valve assembly DS at an interface. Adjuster KB may comprise an operator control. Adjuster KB may comprise a knob. Adjuster KB may be coupled to shaft SH. Adjuster KB may be within cover CP. Adjuster KB may comprise a rotatable operator control. Adjuster KB may be configured to adjust direction of air flow and volume of air flow. Adjuster KB may be configured to adjust direction of air flow at outlet OT and volume of air flow at inlet IN. Adjuster KB may be configured to adjust direction of air flow through outlet OT and volume of air flow through outlet OT. Valve assembly DS may comprise a set of valves DV configured to adjust volume of air flow. Valve assembly DS may be configured to provide a closed position to obstruct air flow and an open position to permit air flow. Vane assembly VS may comprise a set of vanes VN. Vane assembly VS may comprise a header.

Vane assembly VS may be at least partially within cover CP. Vane assembly VS may be configured to move within cover CP to adjust the direction of air flow at outlet OT. Vane assembly VS may be coupled to adjuster KB at a joint JT. Vane assembly VS may be configured to pivot at joint JT to adjust the direction of air flow at outlet OT. Vane assembly VS may comprise a set of vanes VN configured to rotate at joint JT to adjust direction of air flow. Joint JT may comprise a ball joint. Joint JT may comprise a universal joint. Vane assembly VS may comprise a circular structure. Vane assembly VS may comprise a set of vanes VN configured to guide air flow. Adjuster KB may be configured to adjust vane assembly VS. Valve assembly DS may be at inlet IN. Valve assembly DS may be configured to open and to close inlet IN. Valve assembly DS may be within passage. Valve assembly DS may comprise a set of valves DV. Set of valves DV may be movable between an open position and a closed position. Housing HS may comprise a seat ST for set of valves DV. Seat ST may comprise a seal for air flow at inlet IN. Shaft SH may couple adjuster KB to valve assembly DS. Shaft SH may be coupled to valve assembly DS by an interface. The interface may comprise a mechanism. The mechanism may comprise a gear mechanism. Valve assembly DS may comprise a set of valves DV coupled to shaft SH at the mechanism. Set of valves DV may comprise a set of doors. The set of doors may be rotatably movable between an open position and a closed position. The set of doors may comprise flaps. Adjuster KB may be configured to adjust valve assembly DS. Adjuster KB may be configured to adjust volume of air flow. Adjuster KB may be configured to adjust valve assembly DS between an open position and a closed position. Cover CP may comprise a cap. The vane assembly VS may comprise a bezel NS; the vane assembly VS may be movable within the cover/cap CP. Adjuster KB may comprise a knob on vane assembly VS. Adjuster KB may comprise a knob within cover CP connected to shaft SH. The knob may be configured to adjust position of vane assembly VS to direct air flow at outlet OT. The knob may be configured to adjust position of valve assembly DS between an open position and a closed position. The assembly may comprise a light module LM configured to provide illumination at outlet OT. Light module LM may comprise a light source LS. Light source LS may comprise an LED. Light source LS may be configured to illuminate a light-transmissive element within cover CP. Vane assembly VS may comprise the light transmissive element. The assembly may comprise a light guide LG between light source LS and the light transmissive element. Light guide LG may comprise a section within shaft SH. Illumination at outlet OT may comprise a visual effect. Illumination at outlet OT may comprise illumination of a set of light transmissive elements within cover CP. Illumination at outlet OT may comprise illumination of adjuster KB.

According to an exemplary embodiment as shown schematically in FIGS. 3A-3C, 4A-4C, 5A, 5B, 6A-6F, 7A-7F, 8A-8D, 9A-9D, 10A-10D, 11A-11D, 12A-12D, 13A-13D, 14A-14B, 15 and 16, a vehicle interior component providing a passage for airflow may comprise a valve assembly DS comprising a door, a vane assembly VS comprising a guide configured to guide airflow and a knob. The knob may be configured to move the door between an open position to allow airflow and a closed position to block airflow; the knob may be configured to move the guide between a first position to guide airflow in a first direction and a second position to guide airflow in a second direction. The knob may be configured to translate to move the door between the open position and the closed position. The knob may be configured to rotate to move the guide between the first position and the second position. The guide may comprise a set of vanes VN.

According to an exemplary embodiment as shown schematically in FIGS. 3A-3C, 4A-4C, 5A, 5B, 6A-6F, 7A-7F, 8A-8D, 9A-9D, 10A-10D, 11A-11D, 12A-12D, 13A-13D, 14A-14B, 15 and 16, a vehicle interior component providing a passage for airflow may comprise a valve assembly DS comprising a door, a vane assembly VS comprising a guide configured to guide airflow, a knob configured to move at least one of the door or the guide and a light source LS. Light source LS may be configured to illuminate the knob. The component may comprise a light guide LG configured to direct light from light source LS toward the knob. Light guide LG may comprise an angled surface configured to direct light from a transverse direction to a direction generally orthogonal to the transverse direction. The component may comprise a shaft SH coupled to the knob. Shaft SH may be configured to move the door between an open position to allow airflow and a closed position to block airflow. Shaft SH may comprise an opening. The component may comprise a light guide LG configured to direct light from light source LS toward the knob; light guide LG may be positioned within the opening of shaft SH.

According to an exemplary embodiment as shown schematically in FIGS. 3A-3C, 4A-4C, 5A, 5B, 6A-6F, 7A-7F, 8A-8D, 9A-9D, 10A-10D, 11A-11D, 12A-12D, 13A-13D, 14A-14B, 15 and 16, an air vent assembly for a vehicle interior component configured to provide air flow at an outlet OT from a ventilation system comprising a housing HS providing a passage for air flow between an inlet IN and outlet OT, a cover CP, a vane assembly VS configured to adjust direction of air flow at outlet OT, a valve assembly DS configured to adjust volume of air flow from inlet IN, a shaft SH within passage, an adjuster KB configured to adjust at least one of direction of air flow and/or volume of air flow and a light module LM configured to provide illumination at outlet OT. Illumination at outlet OT may comprise illumination of a set of light-transmissive elements within cover CP to provide a visual effect.

According to an exemplary embodiment, the adjuster of the air valve assembly may comprise a rotatable operator control configured to adjust volume of air flow at the valve assembly; the adjuster may be configured to adjust volume of air flow independently of direction of air flow. According to an exemplary embodiment, the vane assembly may be coupled to the adjuster so that the vane assembly can be rotated. According to an exemplary embodiment, the air valve assembly may comprise a joint on the shaft; the joint may comprise a rotating joint; the joint may comprise a ball joint; the joint may comprise a universal joint. The shaft may be coupled to the vane assembly by a joint such as a ball joint. The adjuster may be coupled to the shaft by a joint such as a universal joint. The adjuster may comprise an operator control. The adjuster may comprise a knob (e.g. configured to rotate to adjust the air flow volume at the door mechanism and to move/swivel the vane assembly within the cover/cap). The shaft may be coupled to the valve assembly at an interface (e.g. a door/gear mechanism).

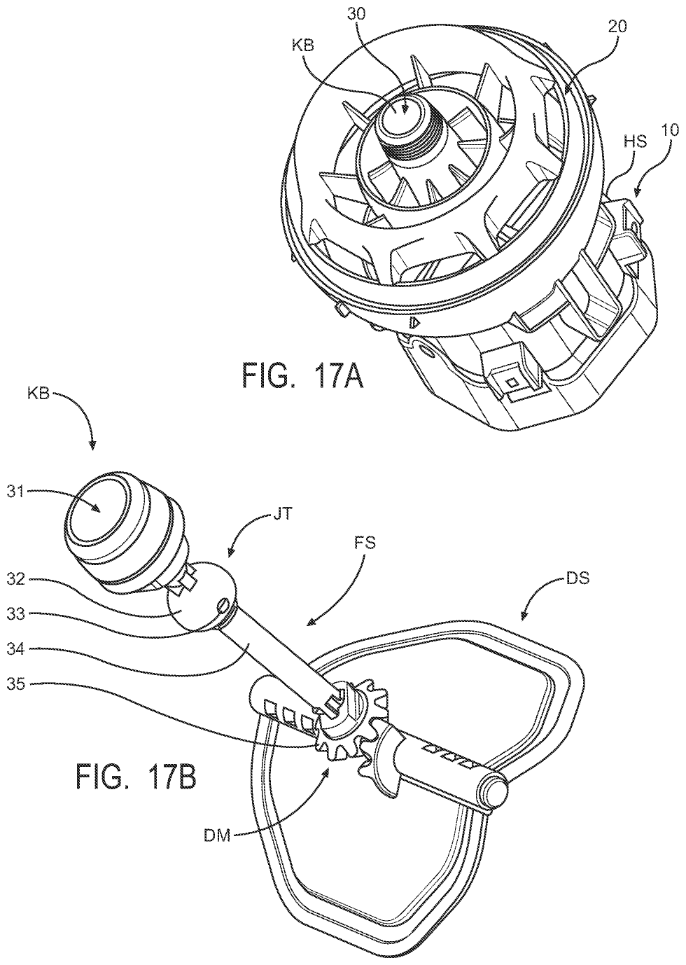

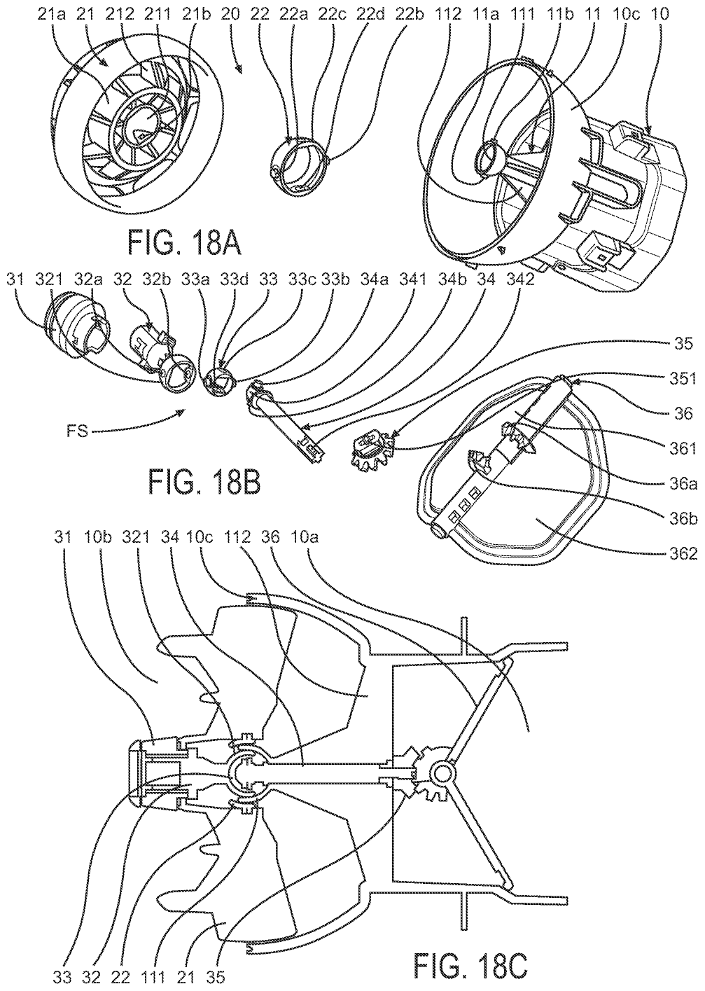

According to an exemplary embodiment as shown schematically in FIGS. 17A, 17B and 18A-18C, an air conditioning device shown as air vent assembly AV may comprise an air direction transmission structure and an air volume transmission structure. See also FIG. 2 (showing HVAC system). The air direction transmission structure and the air volume transmission structure may be arranged as a shaft assembly FS within a shell shown as housing HS. A shell cavity may protrude axially out of an interior of the shell. The air direction transmission structure may be mounted on an outside of the shell cavity to adjust a blowing angle. The air volume transmission structure may be mounted on an inside of the shell cavity to adjust a blowing force. The air volume transmission structure may comprise a knob assembly providing an operator control/adjuster shown as knob KB, an air volume bushing, a transmission shaft and an air door of a door assembly DS with door mechanism DM. The transmission shaft may be connected with the air door. The knob assembly may be mounted on the transmission shaft through an air volume universal joint pair shown as joint/assembly JT by means of the air volume bushing. A knob spherical cavity may protrude out of the knob assembly; the knob spherical cavity may comprise opposite knob characteristic holes; the transmission shaft may comprise opposite transmission characteristic shafts; the air volume bushing may be provided between the knob spherical cavity and the transmission shaft; the transmission shaft may comprise opposite air volume characteristic shafts and opposite air volume characteristic holes; the air volume characteristic shafts may be inserted into the knob characteristic holes; the transmission characteristic shafts may be inserted into the air volume characteristic holes to form an air volume universal joint pair. An axis of the air volume characteristic shafts may be perpendicular to a line connecting the air volume characteristic holes. The air direction transmission structure may comprise an air guiding grill and an air direction bushing; the air guiding grill may be mounted on the shell cavity through an air direction universal joint pair by means of the air direction bushing. An interior of the air guiding grill may be provided with a sleeve in an axial direction; the sleeve may comprise opposite grill characteristic holes; the shell cavity may comprise opposite shell characteristic shafts; the air direction bushing may be provided between the sleeve and the shell cavity; the air direction bushing may comprise opposite air direction characteristic shafts and opposite air direction characteristic holes; the air direction characteristic shafts may be inserted into the grill characteristic holes for cooperation; the shell characteristic shafts may be inserted into the air direction characteristic holes to form an air direction universal joint pair. An axis of the air direction characteristic shafts may be perpendicular to a line connecting the air direction characteristic holes. The air direction transmission structure may comprise an air guiding grill, a grill carrier, and an elastic body; the air guiding grill may be mounted on the shell cavity through a ball joint pair by means of the grill carrier and the elastic body. The grill carrier may comprise a spherical inner side wall adapted to a shape of the shell cavity to be loaded on the outside of the shell cavity; an annular groove may be formed in the spherical inner side wall; the elastic body may be accommodated in the annular groove to form a ball joint pair. The knob assembly may comprise a knob mounted on the air guiding grill configured to rotate about a central axis of the air guiding grill and a knob carrier captured inside the knob. The air volume transmission structure may comprise a gear connected between the transmission shaft and the air door.

### Exemplary Embodiment—B

According to an exemplary embodiment as shown schematically in FIGS. 17A-17B, an air conditioning device may comprise an air direction transmission structure 20 for adjusting a blowing angle and an air volume transmission structure 30 for adjusting a blowing force, both of which may be mounted on a shell 10. The air conditioning device may be an automobile interior part, which may be permanently arranged on a circular air outlet of an instrument panel or a central control panel of the automobile and used for improving air circulation in the automobile.

According to an exemplary embodiment as shown schematically in FIGS. 18A-18C, the shell 10 may be axially open and may comprise an air flow inlet 10a and an air flow outlet 10b. The shell 10 may comprise a cylindrical body which may be flared to a shell spherical surface 10c on the air flow outlet 10b side. An interior of the shell 10 may be provided with a cylindrical bearing body 11 in an axial direction. The bearing body 11 may comprise an integrally formed shell cavity 111 protruding from an end, adjacent to the air flow outlet 10b, of a connecting body 112 and the connecting body 112 projecting in a direction orthogonal to a central axis of the shell 10 to fix the shell cavity 111 inside the shell 10. The bearing body 11 may be integrally formed with the cylindrical body/shell spherical surface 10c or may be separately mounted. The shell 10 may be integrally formed. An outer side wall of the shell cavity 111 may be provided with opposite shell characteristic shafts 11a and 11b for matching with the air direction transmission structure 20. As shown schematically in FIG. 18A, the air direction transmission structure 20 may comprise an air guiding grill 21 and an air direction bushing 22; the air guiding grill 21 may be mounted on an outside of the shell cavity 111 within the shell spherical surface 10c of the shell 10 through an air direction universal joint pair (see FIG. 18C) by means of the air direction bushing 22. The air guiding grill 21 may comprise a grill spherical surface which may be arbitrarily swung at a slight interval with respect to the shell spherical surface 10c. An interior of the air guiding grill 21 may be provided, in an axial direction, with a sleeve 211 which may be mounted on an inner wall of the grill spherical surface by a plurality of air guide vanes 212 arranged radially in a projection shape. The sleeve 211 may be integrally formed with the air guide vanes 212 and the grill spherical surface or may be separately mounted. The air guiding grill 21 may be integrally formed. An inner side wall of the sleeve 211 may be provided with opposite grill characteristic holes 21a and 21b for cooperating with the air direction bushing 22. The air direction bushing 22 may be accommodated inside the sleeve 211 and may be shaped to be adaptively loaded on the outside of the shell cavity 111. The air direction bushing 22 may comprise opposite air characteristic shafts 22a and 22b that are inserted into the grill characteristic holes 21a and 21b, respectively, of the sleeve 211 for cooperation. The air direction bushing 22 may comprise opposite air characteristic holes 22c and 22d that accommodate shell characteristic shafts 11a and 11b, respectively, inserted therein for cooperation. Axes of the air characteristic shafts 22a and 22b may be perpendicular to a line connecting the air direction characteristic holes 22c and 22d. The air guiding grill 21, the air direction bushing 22 and the shell cavity 111 of the shell 10 may constitute an air direction universal joint pair, as shown schematically in FIG. 18C.

According to an exemplary embodiment as shown schematically in FIGS. 17B and 18B, the air volume transmission structure 30 may comprise a knob 31, a knob carrier 32, an air volume bushing 33, a transmission shaft 34, a gear 35, and an air door 36. The knob carrier 32 may be connected with the knob 31 and may be mounted on the transmission shaft 34 through an air volume universal joint pair (see FIG. 18C) by means of the air volume bushing 33. The transmission shaft 34 may be connected with the air door 36 via the gear 35 to drive opening and closing of the air door 36 via the knob 31. The knob 31 may be mounted on the air guiding grill 21 and may be rotated about a central axis of the air guiding grill 21. The air guiding grill 21 may be swung synchronously by swinging left and right, up and down to adjust the air direction. On one end, adjacent to the air flow outlet 10b, of the knob carrier 32 may be captured inside the knob 31 to collectively constitute the knob assembly. A knob spherical cavity 321 may protrude out of an end, remote from the air flow outlet 10b, of the knob carrier 32. The knob spherical cavity 321 may extend into the inside of the shell cavity 111 of the shell 10 (see FIG. 18C) and may comprise opposite knob characteristic holes 32a and 32b. The air volume bushing 33 may be accommodated inside the knob spherical cavity 321 (see FIG. 18C) and may be provided with opposite air volume characteristic shafts 33a and 33b. The air volume characteristic shafts 33a and 33b may be respectively inserted into the knob characteristic holes 32a and 32b of the knob spherical cavity 321 for cooperation. The air volume bushing 33 may comprise opposite air volume characteristic holes 33c and 33d. A spherical boss 341 may protrude out of one end, adjacent to the air flow outlet 10b, of the transmission shaft 34, is accommodated inside the air flow bushing 33 (see FIG. 18C) and may be provided with opposite transmission characteristic shafts 34a and 34b which are respectively inserted into the air volume characteristic holes 33c and 33d of the air volume bushing 33 for cooperation. Axes of the air volume characteristic shafts 33a and 33b may be perpendicular to a line connecting the air volume characteristic holes 33c and 33d. The knob carrier 32 of the knob assembly, the air volume bushing 33 and the spherical boss 341 of the transmission shaft 34 may constitute an air volume universal joint pair, as shown schematically in FIG. 18C. On one end, adjacent to the air flow inlet 10a, of the transmission shaft 34 is provided with a cross clamping structure 342, a cross groove 351 is formed in the middle of the gear 35, and the cross clamping structure 342 is inserted into the cross groove 351 to mount the transmission shaft 34 and the gear 35. The air door 36 may comprise a shape adapted to an inner surface of the cylindrical body of the shell 10 and may be composed of valves 361 and 362, shaft portions of which are arranged coaxially in a direction orthogonal to an axial direction of the shell 10, and the valves 361 and 362 are provided with sector gear features 36a and 36b, respectively. The sector gear features 36a and 36b may be arranged at positions, circumferentially offset from each other, on the shaft portions of the valves 361 and 362 and mesh with gear features on the gear 35 to form a gear pair to effect opening and closing of the air door 36 by operating the knob 31. The valves 361 and 362 may be semi-circular in shape.

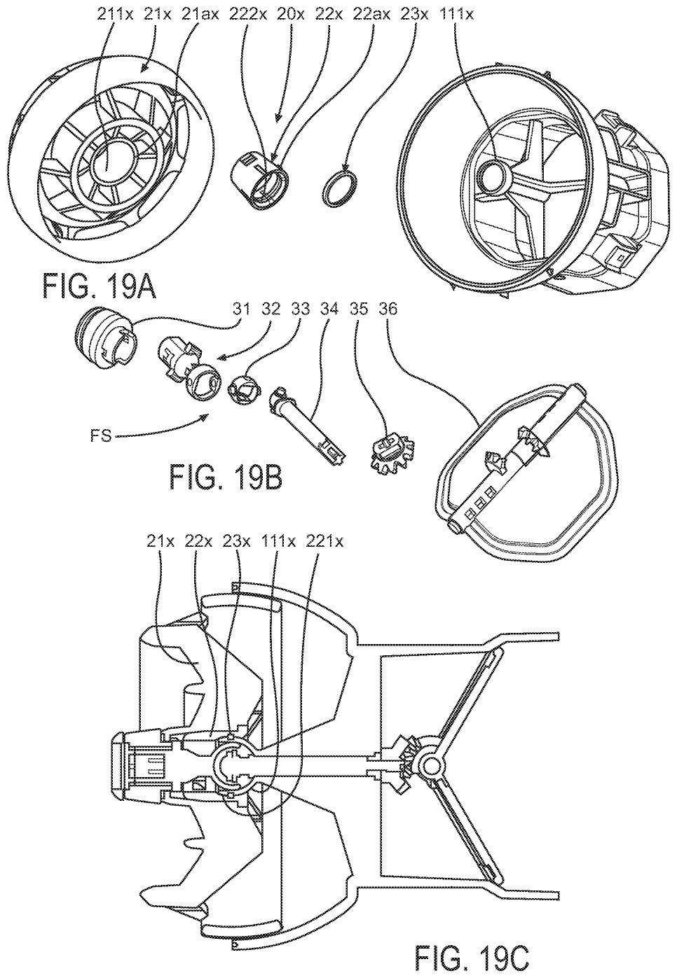

According to an exemplary embodiment as shown schematically in FIGS. 19A-19C, an air conditioning device may comprise an air direction transmission structure 20x for adjusting a blowing angle and an air volume transmission structure 30 for adjusting a blowing force, both of which may be mounted on a shell. An outer side wall of the shell cavity 111x does not have shell characteristic shafts. The air direction transmission structure 20x may comprise an air guiding grill 21x, a grill carrier 22x and an elastic body 23x; the air guiding grill 21x may be mounted on the shell cavity 111x through a ball joint pair by means of the grill carrier 22x and the elastic body 23x. An inner side wall of the sleeve 211x in the axial direction of an interior of the air guiding grill 21x may be provided with a grill groove 21ax. The grill carrier 22x may be shaped to be adaptively accommodated inside the sleeve 211x and may comprise a carrier projection 22ax which is inserted into a grill groove 21ax of the sleeve 211x for cooperation. The grill carrier 22x may comprise a spherical inner side wall 221x adapted to a shape of the shell cavity 111x to be loaded on the outside of the shell cavity 111x. The spherical inner side wall 221x may be provided with an annular groove 222x in which an elastic body 23x is accommodated for cooperation. The air guiding grill 21x, the grill carrier 22x and the shell cavity 111x may constitute a ball joint pair, as shown schematically in FIG. 19C. The elastic body 23x may comprise elastic material such as rubber or silica gel.

According to an exemplary embodiment an air conditioning device may comprise an air direction transmission structure and an air volume transmission structure. The air direction transmission structure and the air volume transmission structure may be arranged on a shell. A shell cavity may axially protrude out of an interior of the shell. The air direction transmission structure may be mounted on an outside of the shell cavity to adjust a blowing angle. The air volume transmission structure may be mounted on an inside of the shell cavity to adjust a blowing force. The air volume transmission structure may comprise a knob assembly, an air volume bushing, a transmission shaft and an air door. The transmission shaft may be connected with the air door. The knob assembly may be mounted on the transmission shaft through an air volume universal joint pair by means of the air volume bushing.

According to an exemplary embodiment, a knob spherical cavity may protrude out of the knob assembly, the knob spherical cavity may be provided with opposite knob characteristic holes, the transmission shaft may be provided with opposite transmission characteristic shafts, and the air volume bushing provided between the knob spherical cavity and the transmission shaft may be provided with opposite air volume characteristic shafts and opposite air volume characteristic holes, the air volume characteristic shafts being inserted into the knob characteristic holes for cooperation, the transmission characteristic shafts being inserted into the air volume characteristic holes for cooperation, forming the air volume universal joint pair.

According to an exemplary embodiment, axes of the air volume characteristic shafts may be perpendicular to a line connecting the air volume characteristic holes.

According to an exemplary embodiment, the air direction transmission structure may comprise an air guiding grill and an air direction bushing; the air guiding grill may be mounted on the shell cavity through an air direction universal joint pair by means of the air direction bushing.

According to an exemplary embodiment, an interior of the air guiding grill may be provided with a sleeve in an axial direction, the sleeve having opposite grill characteristic holes, the shell cavity having opposite shell characteristic shafts, the air direction bushing provided between the sleeve and the shell cavity having opposite air direction characteristic shafts and opposite air direction characteristic holes, the air direction characteristic shafts being inserted into the grill characteristic holes for cooperation, the shell characteristic shafts being inserted into the air direction characteristic holes for cooperation, forming the air direction universal joint pair.

According to an exemplary embodiment, axes of the air direction characteristic shafts may be perpendicular to a line connecting the air direction characteristic holes.

According to an exemplary embodiment, the air direction transmission structure may comprise an air guiding grill, a grill carrier, and an elastic body; the air guiding grill may be mounted on the shell cavity through a ball joint pair by means of the grill carrier and the elastic body.

According to an exemplary embodiment, the grill carrier may comprise a spherical inner side wall adapted to a shape of the shell cavity to be loaded on the outside of the shell cavity, an annular groove may be formed in the spherical inner side wall, and the elastic body may be accommodated in the annular groove for cooperation, forming a ball joint pair.

According to an exemplary embodiment, the knob assembly may comprise a knob mounted on the air guiding grill to be rotatable about a central axis of the air guiding grill and a knob carrier captured inside the knob.

According to an exemplary embodiment, the air volume transmission structure may comprise a gear connected between the transmission shaft and the air door.

According to an exemplary embodiment, an independent operation of the air direction and the air volume can be realized, and a situation that the operation is not smooth or the air door cannot be normally closed due to weakening of the elasticity of a spring and the like in the prior art can be prevented. Moreover, according to the air conditioning device of the present disclosure, any adjustment of different blowing angles can be realized, the blowing volume and the blowing angle are not interfered with each other, and the operation is simpler and more reliable.

According to an exemplary embodiment, an air conditioning device may comprise an air direction transmission structure and an air volume transmission structure. The air direction transmission structure and the air volume transmission structure may be arranged on a shell. A shell cavity may axially protrude inside the shell. The air direction transmission structure may be mounted on an outside of the shell cavity to adjust a blowing angle. The air volume transmission structure may be mounted on an inside of the shell cavity to adjust a blowing force.

The air volume transmission structure may comprise a knob assembly, an air volume bushing, a transmission shaft and an air door. The transmission shaft may be connected with the air door. The knob assembly may be mounted on the transmission shaft through an air volume universal joint pair by means of the air volume bushing. Independent operation of the air direction and the air volume may be realized.

According to an exemplary embodiment the air vent assembly may be configured to provide for operation permitting adjustment of air flow volume and air flow direction that is smooth and in which the air door/valve can be normally closed without weakening of the elasticity (e.g. spring action of elements) and in which adjustment of different angles of air flow direction may be realized and in which the air flow volume and the air flow direction (angle) are independent and in which the operation is simple and reliable.

Reference Symbol List

| | REFERENCE |
|---|---|
| ELEMENT, PART OR COMPONENT | SYMBOL |
| Vehicle | V |
| Interior | I |
| Ventilation system | HVAC |
| (heating, ventilation, and air conditioning system) | |
| Component | C |
| Instrument panel | IP |
| Door panel | DP |
| Floor console | FC |
| overhead console | OC |
| Air vent assembly | AV |
| Inlet | IN |
| Outlet | OT |
| Air flow | AF |
| Cap/cover | CP |
| Housing/shell | HS |
| Seat/seal (valve seat) | ST |
| Vane assembly/header | VS |
| Vanes | VN |
| Adjuster/knob (operator control) | KB |
| Shaft assembly | FS |
| Shaft | SH |
| Joint | JT |
| Door assembly (Valve assembly) | DS |
| Door mechanism | DM |
| Door/valve | DV |
| Door flap | DF |
| Door frame (door) | DT |
| Light module | LM |
| Light source | LS |
| LED | LED |
| Light guide (sections) | LG |
| Light (visual effect) | L |
| cap (adjuster/knob) | KC |
| Knob insert | KBX |
| housing (adjuster/knob) | KS |
| Insert/light transmissive element | JTX |
| housing/socket (joint) | JS |
| ring (joint) | TP |
| bushing (shaft) | BS |
| universal joint | RTX |
| gear (interface/shaft) | SS |
| bezel | NS |
| ring (vane assembly) | TR |
| retainer (vane assembly) | RTN |
| ring (vane assembly) | VP |
| Shell | 10 |
| air direction transmission structure | 20 |
| air volume transmission structure | 30 |
| Knob | 31 |
| Knob carrier | 32 |
| air volume bushing | 33 |
| transmission shaft | 34 |
| gear | 35 |
| air door | 36 |
| air flow inlet | 10a |
| air flow outlet | 10b |
| shell spherical surface | 10c |
| cylindrical bearing body | 11 |
| shell characteristic shaft | 11a |
| shell characteristic shaft | 11b |
| integrally formed shell cavity | 111 |
| connecting body | 112 |
| air guiding grill | 21 |
| grill characteristic hole | 21a |
| grill characteristic hole | 21b |
| Sleeve | 211 |
| Air guide vane | 212 |
| air direction bushing | 22 |
| air characteristic shaft | 22a |
| air characteristic shaft | 22b |
| air direction characteristic hole | 22c |
| air direction characteristic hole | 22d |
| knob characteristic hole | 32a |
| knob characteristic hole | 32b |
| knob spherical cavity | 321 |
| air volume characteristic shaft | 33a |
| air volume characteristic shaft | 33b |
| air volume characteristic hole | 33c |
| air volume characteristic hole | 33d |
| transmission characteristic shaft | 34a |
| transmission characteristic shaft | 34b |
| spherical boss | 341 |
| cross clamping structure | 342 |
| cross groove | 351 |
| sector gear feature | 36a |
| sector gear feature | 36b |
| Valve | 361 |
| Valve | 362 |
| air direction transmission structure | 20x |
| air guiding grill | 21x |
| grill groove | 21ax |
| sleeve | 211x |
| grill carrier | 22x |
| carrier projection | 22ax |
| spherical inner side wall | 221x |
| annular groove | 222x |
| elastic body | 23x |
| shell cavity | 111x |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

1. A component for a vehicle interior providing a passage for airflow and comprising:
(a) a valve assembly comprising a door;
(b) a vane assembly comprising a guide configured to guide airflow;
(c) a knob configured to move at least one of the door or the guide; and
(d) a light source;
wherein the light source is configured to illuminate the knob.

2. The component of claim 1 further comprising a light guide configured to direct light from the light source toward the knob.

3. The component of claim 2 wherein the light guide comprises an angled surface configured to direct light from a transverse direction to a direction generally orthogonal to the transverse direction.

4. The component of claim 1 further comprising a shaft coupled to the knob.

5. The component of claim 4 wherein the shaft is configured to move the door between an open position to allow airflow and a closed position to block airflow.

6. The component of claim 5 wherein the shaft comprises an opening.

7. The component of claim 6 further comprising a light guide configured to direct light from the light source toward the knob; wherein the light guide is positioned within the opening of the shaft.

8. An air conditioning device for a vehicle interior comprising an air direction transmission structure and an air volume transmission structure;
wherein the air direction transmission structure and the air volume transmission structure are arranged on a shell;
wherein a shell cavity axially protrudes out of an interior of the shell;
wherein the air direction transmission structure is mounted on an outside of the shell cavity to adjust a blowing angle;
wherein the air volume transmission structure is mounted on an inside of the shell cavity to adjust a blowing force;
wherein the air volume transmission structure comprises a knob assembly, an air volume bushing, a transmission shaft and an air door;
wherein the transmission shaft is connected with the air door;
wherein the knob assembly is mounted on the transmission shaft through an air volume universal joint pair by means of the air volume bushing.

9. The air conditioning device of claim 8 wherein a knob spherical cavity protrudes out of the knob assembly; wherein the knob spherical cavity comprises opposite knob characteristic holes; wherein the transmission shaft comprises opposite transmission characteristic shafts; wherein the air volume bushing is provided between the knob spherical cavity and the transmission shaft; wherein the transmission shaft comprises opposite air volume characteristic shafts and opposite air volume characteristic holes; wherein the air volume characteristic shafts are inserted into the knob characteristic holes; wherein the transmission characteristic shafts are inserted into the air volume characteristic holes to form an air volume universal joint pair.

10. The air conditioning device of claim 9 wherein an axis of the air volume characteristic shafts is perpendicular to a line connecting the air volume characteristic holes.

11. The air conditioning device of claim 8 wherein the air direction transmission structure comprises an air guiding grill and an air direction bushing; wherein the air guiding grill is mounted on the shell cavity through an air direction universal joint pair by means of the air direction bushing.

12. The air conditioning device of claim 11 wherein an interior of the air guiding grill is provided with a sleeve in an axial direction; wherein the sleeve comprises opposite grill characteristic holes; wherein the shell cavity comprises opposite shell characteristic shafts; wherein the air direction bushing is provided between the sleeve and the shell cavity; wherein the air direction bushing comprises opposite air direction characteristic shafts and opposite air direction characteristic holes; wherein the air direction characteristic shafts are inserted into the grill characteristic holes for cooperation; wherein the shell characteristic shafts are inserted into the air direction characteristic holes to form an air direction universal joint pair.

13. The air conditioning device of claim 12 wherein an axis of the air direction characteristic shafts is perpendicular to a line connecting the air direction characteristic holes.

14. The air conditioning device of claim 8 wherein the air direction transmission structure comprises an air guiding grill, a grill carrier, and an elastic body; wherein the air guiding grill is mounted on the shell cavity through a ball joint pair by means of the grill carrier and the elastic body.

15. The air conditioning device of claim 8 wherein the grill carrier comprises a spherical inner side wall adapted to a shape of the shell cavity to be loaded on the outside of the shell cavity; wherein an annular groove is formed in the spherical inner side wall; wherein the elastic body is accommodated in the annular groove to form a ball joint pair.

16. The air conditioning device of claim 15 wherein the knob assembly comprises a knob mounted on the air guiding grill configured to rotate about a central axis of the air guiding grill and a knob carrier captured inside the knob.

17. The air conditioning device of claim 8 wherein the air volume transmission structure comprises a gear connected between the transmission shaft and the air door.

18. An air vent assembly for a vehicle interior component configured to provide air flow at an outlet from a ventilation system comprising:
(a) a housing providing a passage for air flow between an inlet and the outlet;
(b) a cover;
(c) a vane assembly configured to adjust direction of air flow at the outlet;
(d) a valve assembly configured to adjust volume of air flow from the inlet;
(e) a shaft within the passage;
(f) an adjuster configured to adjust at least one of direction of air flow and/or volume of air flow;
(g) a light module configured to provide illumination at the outlet;
wherein illumination at the outlet comprises illumination of a set of light-transmissive elements within the cover to provide a visual effect.

19. The air vent assembly of claim 18 wherein the adjuster is configured independently to adjust direction of air flow and volume of air flow.

20. The air vent assembly of claim 18 wherein the light module comprises a light source; wherein the light source is configured to illuminate a light-transmissive element within the cover.
